(19) United States
(12) Patent Application Publication
(10) Pub. No.: US 2002/0130088 A1
(43) Pub. Date: Sep. 19, 2002

(54) Colloidal solids removal and improved seawater desalting

(76) Inventor: Paul I. Rongved, North Miami Beach, FL (US)

Correspondence Address: PAUL I. RONGVED, SUITE 2208, 210 174TH STREET, NORTH MIAMI BEACH, FL, 33160, US

(21) Appl. No.: 09/808,295

(22) Filed: Mar. 14, 2001

(51) Int. Cl. C02F 1/463

(52) U.S. Cl. 210/721; 210/748; 205/756

(57) ABSTRACT

The present invention relate to collecting colloidal solids in suspension for removal, for its drying and recovery, including in a scrubber as shown in my U.S. Pat. No. 6,180,012, where colloidal solids is made and is in suspension and in its clarifier located below, where some of the colloidal solids is washed down and is in suspension in desalinated seawater. Tubes with negative DC charge, attract build up of colloidal solids on their surfaces, and one loaded tube at the time is removed to a room or enclosure for drainage and drying with dry air. Thereafter the tube's DC charge is changed to positive, loosening the tube's grip and attraction to the colloidal solids which is blown through an outlet into a settling tank and down on a bottom screw conveyor that delivers the dry colloidal solids with little adhesion, to centrifuge for separation of the solids. From one of the solids is ammonia recycled for the process, which is important for saving cost, energy and production of C₂. The present invention also relates to processes for further improving much desalination of potable seawater with less emission of CO₂ and sterilization, flocculation and removal of organics all important for drinkable water by the present invented processes.

### BACKGROUND OF INVENTION

Colloidal particles or solids exist in solutions or are created by some processes, as in my patent U.S. Pat. No. 6,180,012, these solids having a much larger specific gravity than the solution, still remain suspended and they would require a very long time to settle in standard depth clarifier, which would slow the processes and make it very expansive to collect and recover, and some of said solids will dissolve in the solution and be lost for recovery.

When ammonia, NH₃ is mixed into seawater the CL of its salt molecules, NaCL connect to the ammonia and water, forming the compound NaCLNH₄OH, (this is not understood by many professionals, not even by some professors). This weakend CL's the bond to Na in the salt compound in seawater, which then is sprayed as fine mist into a scrubber, where CO₂ gas enters, seeks and connect to said Na and is breaking said salt compound apart into two colloidal solid: Soda Ash, Na₂CO₃, a valuable and salable product, and Ammonium chloride, NH₄CL, which can be recycled to NH₃ for reuse in the process, and HCL an important acid for many industries. But these, being individual suspended molecules are very difficult and costly to collect and remove.

The present invention is therefore of great importance indeed, providing a practical process, at low cost, for rapid collection, removal, drainage and recycling colloidal solids, a specially recycling of ammonia for use in said process, and therewith avoiding more production of CO₂ than is removed by the process.

The present invention, also shows how to sterilize and remove organics in the seawater, as well as a practical method for removing all objectionable salt in potable seawater, and reducing CO₂ emission.

### SUMMERY OF INVENTION

The above and other object and advantages are obtained in accordance with the present invention including a process or method for collecting suspended colloidal solids in a solution, for removing and drying, which is characterized by the steps: a) Adding and employing iron tubes having a DC switch with double wire chord, which supply each tube with a positive charge through one wire and can be switched to a negative charge through the other wire. b) Any of said tubes having a negative charge are causing attraction and build up of said colloidal solids on their surfaces. c) One at the time of said tubes with negative charge and attached colloidal solids is moved from said solution for drainage and drying by circulating very dry air in an enclosure before the negative charge is switched to positive, loosing said tube's attraction and freeing said build up of colloidal solids, which then is blown down through an outlet for removal and easier separation and recovery of said dried material.

Said solution can be inside a scrubber as shown in my U.S. Pat. No. 6,180,012, where colloidal solids are made and in suspension. All said tubes with closed top and bottom, will be hanging from a closed loop conveyor, mounted to brackets under a rain shield along surrounding walls of said scrubber, which has a room attached with and opening and door to said scrubber, and said closed loop conveyor has a narrow part extending into said room. One at the time of said tubes is moved into said room with negative charge and colloidal solids attached for drainage and drying. by circulating very dry air, befre said door is closed and said negative charge is switched to positive, causing said colloidal solids to become loose and very dry air blows it through an outlet for removal. Rotating DC outlets are mounted on a centrically located bracket near the top in said scrubber, each connect to said chord from said DC switch on top of each of said tubes. When said scrubber is to wide for use of chords, an AC receiver with a rectifier, powers said DC switch on each of said tubes. Said door from said room to said scrubber, is a nylon door rolled up over a guide shaft on a drive shaft, where top of door is connected. Strings fastened each side at bottom of said door, extend down below door opening over a spring loaded shaft and up over said guide roller and is fasten opposite way each side of said door on said drive shaft with circular separation plates and a drive sprocket, which i is unwinding and driving down said door for closing as strings rolls up, and driving and winding up winding down said door for opening as strings unwind.

Some colloidal solids are washed down from said scrubber and is in suspension in desalted seawater in a clarifier below, which will have an overflow duct attached, with an opening near bottom of said clarifier wall connecting to said overflow duct, wherein some of said tubes are placed, having holes near top and bottom and with said DC switch, chord and a negative charge, they will

They will attract build up of said colloidal solids on the inner and outer surfaces in the streaming water. One of said tubes at the time will be lifted up above said overflow weir into an enclosure attached to said scrubber, for drainage and drying by circulating very dry air, before said enclosure's bottom is closed and said DC charge of said tube is switched to positive, freeing and blowing with very dry air said colloidal solids through an outlet for recovery.

At top of said room and said enclosure is an air fans with an air conditioning unit, for circulating very dry air up during drying of said connected colloidal solids, and blowing very dry air down for removal of said loosed built up of colloidal solids through said outlet into a large and tall tank, with cyclonic and centrifugat action and renewed DC charge for separation of air, the heavy solid and the light solid, which is used for recycling ammonia.

For further reduction of salt in my already patented process for desalination of seawater, three of said scrubbers with clarifier below, are placed closely together with said room and enclosure attached to each scrubber, and said overflow duct attached to each clarifier. All said seawater with 3% salt compound is pumped as mist into scrubber No !, its effluent is pumped to scrubber No 2 and its effluent is pumped to scrubber NO 3. To improve said patented process, all of the 102% CO₂ molecules needed to remove all salt molecules, will enter a bottom hole in scrubber No 3 and flow across to top hole directly to top hole in scrubber No 2 and flow across to bottom hole directly to bottom in scrubber No 1, where the remaining 96% of the CO₂ molecules brake apart about 94% of the 3% salt compounds in said seawater. Only 2% of said entering 102% CO₂ is emitted.

Said seawater with remaining 0.15% salt compounds is pumped to scrubber No 2, where 17 CO₂ molecules for each salt compound molecule, are seeking and braking apart practically all of them. In Scrubber No 3 millions of CO₂ molecules are seeking and braking apart any remnant salt compound, leaving the effluent seawater with no objectionable salt.

Said effluent of desalted seawater still contains its plankton and other microscopic creatures, which are desirable for agricultural use, but when this is objectionable the following preprocess can be provided: The incoming seawater is sterilized by ultraviolet light, killing the organics. Said seawater is then flocculated by a vertical shaft aerator at end in a process tank with a freestanding partition. Said aerator is throwing said seawater up and out against surrounding walls where it builds up and is forced down to the bottom and in and up at center of aerator, in a vertical spiral motion as it is being 100% aerated and flocculated repeatedly before it is thrown into an open cannel and return to said aerator on the other side of said free standing partition. The seawater circulates many times in said tank as particles and colloidal material are absorbed by the flocks, before said seawater overflows to a clarifier, where the flock settles as sludge, which is returned to process tank many times before sludge is wasted. Said clarified seawater overflows with organics removed, to start or finish said process of my invention.

### DESCRIPTION OF SPECIFIC EMBODIMENTS

Improved processing methods, in accordance with the present invention, includes beneficial collecting and drying of heavy colloidal solids that, because they are tiny molecule size, will stay in solution during continuous process in the scrubber, where tubes of iron with negative DC are attracting and collecting colloidal solids on their surfaces. One at the time of each loaded tube is removed to an attached room and for drainage and drying with circulating very dry air before he door to said scrubber is closed and the DC charge of the tube is changed to positive and very dry air is blowing the colloidal solids through an outlet, to a settling tank for separation of said two said colloidal solids.

The process is mainly for collecting colloidal solids made and is in suspension in one or more scrubbers as shown in my U.S. Pat. No. 6,160,012 for desalination of seawater. Seawater has a relative uniform salt content of about three weight percent salt. The salt is dissolved in seawater as two ions Na+ and CL−. The Na+ has lost one of its electrons to the CL−, which ties them strongly together in a ionic bond. Each salt molecule in seawater is protected by one +H₂O molecule on one side and one −H₂O molecule on the other side.

When ammonia, NH₃ molecules are mixed in balanced number with salt molecules in seawater, each salt's aggressive CL atom seek and connect to a NH₃ molecule, but a water molecule is also connected there, and it holds on by transferring one of its H-atoms to the ammonia and connect its OH to the new NH₄, forming the salt compound NaCLNH40H, which weakens CL−'s inner bond to Na+.

The seawater with the salt compound is then sprayed as a fine mist in a scrubber, where CO₂ in exhaust or pour is being added. The CO₂ molecules are seeking and connecting to the Na in the salt compounds further weakening the bond t CL and is braking the salt compounds molecule by molecule, apart into two colloidal solids: Sodium carbonate Na₂CO₃, with specific. gravity 2.58 and Ammonium chloride NU₄CL, with specific gravity 1.53

These two colloidal solids, in spite of being very heavy, will not settle because of their very tiny single molecule size, and they remain suspended in the scrubber. Only the present invention as shown with tubes, negatively charged, can collect and remove the colloidal solids from solution the scrubber. Some of the colloidal solids will be washed down by the seawater spray from the scrubber to be suspended in desalinated seawater in the clarifier below The seawater remain cool in the process, its temperature will increase less then 2° C. by hot exhaust gas in the scrubber, but even in this low temperature up to 7 percent of the colloidal solids may dissolve during stay in the seawater and be lost. It is therefore very important to be able to quickly collect, remove and dry for the colloidal solid. For recovery as done in the present invention, where an overflow duct is attached to the clarifier with a connecting opening at the bottom of the clarifiers wall. The area of duct and opening must must be large that flow speed of said seawater is less than 15 cm per second In said overflow duct, said tubes are placed, with a hole top and bottom, and with a negative DC charge, they will collect colloidal solids on both inner and outer surfaces of their walls, and will not obstruct much the streaming water flow. The desalinated seawater overflows a weir at the top, for use in communities.

The speed of seawater through the opening to the overflow duct, does not prevent Magnesium hydroxide, Mg(OH)₂ to precipitate as sludge from the clarifier. Seawater has about 0.3% Magnesium chloride, but the removal of said NaCL salt Sweeten and raise the ph of said seawater, its Magnesium hydroxide will therefore precipitate and be recovered.

One tube at the time with negative charge and attached colloidal solids, is lifted up above said weir, for drainage and drying in an enclosure, which is in line with said overflow duct and attached to the scrubber. After drainage and drying with very dry air circulating, the bottom of enclosure is then closed and the DC charge is changed to positive, freeing said colloidal solids build up and blowing it with very dry air to remove adhesion, through an outlet for separation and recovery.

All colloidal solids being blown by very dry air through an outlet and falls imt a large and tall settling thank onto a bottom screw conveyor connected to a centrifuge or other means for separation of the two dry colloidal solids. The sodium carbonate is a saleable product, and the ammonium chloride, NH₄CL, is recovered by heating in glass lined equipment to 250° C., and forms ammonia gas NH₃ and hydrochloric acid, HCL also a saleable product. The ammonia is recycled for use in said seawater desalination process, saving money and energy. The NCL, a strong acid is important for the metal and metallurgical industries.

My small scrubber—clarifier test unit for my patented desalination of seawater process has repeatedly shown that 95 percent of CO₂ in exhaust, can be removed in one test run. But it has also shown, that the colloidal solids is very difficult to collect and recover.

The present invention as described is therefore very important as a practical method for collection and removal of colloidal solids both in said scrubbers, in said clarifiers, and in the triple unit, which shows how to produce drinkable water from seawater with my present invention also produce valuable products and remove 98% of the CO₂ gas in combustion exhaust from power plant and industrial plant and remove CO₂ gas from the oil and gas drilling operation.

This invention has been disclosed with respect to certain preferred embodiments and it shall be understood that various modifications and variations thereof, obvious to those skilled in the art, will be included within the scope of the appended claims.

1. A process or method for collecting colloidal solids in solution characterized by the following steps:
a) Employing iron tubes in solution with suspended colloidal solids, and each of said tubes having a DC switch with an electric double wire chord, which supply each tube with a negative charge through one wire and can be switched to a positive charge through the other wire.
b) Any of said tubes in solution having negative charge are attracting build up of said colloidal solids on the surface of said tubes.
c) One of said tubes with colloidal solids attached is moved out of said solution into an enclosure for draining and drying of said colloidal solids, before said charge is charged to positive, loosing said tube's attraction to said build up of colloidal solids and with very dry air blow it through an outlet for removal.

2. A process according to claim 1. characterized in that in step a) said solution is inside a scrubber and all said tubes being long and enclosed, hanging from a closed loop conveyor, mounted to brackets under a rain shield along surrounding walls of said scrubber, wherein colloidal solids is being produced or exist in solution.

3. A process according to claims 1-2, characterized in that said scrubber has a room attached, with and opening and door to said scrubber, and said closed loop conveyor has a narrow part extending into said room, and one of said tubes at the time is moved into said room with its negative charge and attached colloidal solids for its drainage and drying with circulating very dry air, thereafter said door is closed and the charge switched to positive, making said colloidal solids become loose for removal through an outlet for valuable recovery.

4. A process according to claims 1-3, characterized in that a central bracket near the top of said scrubbler has rotating DC outlets connecting each of said chords to a DC switch on said tubes.

5. A process according to claims 1-4, characterized in that when said Scrubber are too wide for use of chords, an AC receiver with a rectifier powers said DC switch on said tubes.

6. A process according to claims 2-5, characterized in that said door between said room and said scrubber is a nylon door rolled up over a guide shaft on to a drive shaft, where top of door is connected. Stings each side at bottom of said door extend down below door opening over a spring loaded shaft, which keep strings and door tight, and up over said guide shaft and is fasten opposite way, each side of said door on said drive shaft, that have circular separation plates and a drive sprocket, which is unwinding and closing said door as string roll up, and rolls up to close said door as strings unwind.

7. A process according to claims 1-4, characterized in that in step a) said solution is a liquid, with some colloidal solids washed down from said scrubber to a clarifier below, where said liquid flows through a hole near its bottom up through an attached overflow duct and out over a weir, and said tubes with a hole top and bottom and a DC switch with negative charge is placed in said duct, attracting on the inner and outer surfaces a build up of said colloidal solids.

8. A process according to claim 7, characterized in that one at the time of said tubes with colloidal solids attached is lifted up above said weir into an enclosure attached to said scrubber, and after draining and drying said colloidal solids with upwards circulating very dry air, before changing charge in said tube to positive and very dry air is blowing downwards said colloidal solids and remove it through an outlet.

9. A process accordance to claims 1-7, characterized in that an air fan with an air-conditioning unit at the top of said room and said enclosure are circulating very dry air upwards to dry said connected colloidal solids, and later blow said loose colloidal solids through said outlet into a large and tall tank with cyclonic and centrifugal action and renewed DC charge, for separation of circulating dry air, the heavy sodium carbonate and the light ammonium chloride, which is used for recycling of ammonia gas for said desalination seawater process.

10. A process accordance to processing claims, characterized in that said process is improved for said 3 closely spaced scrubbers with attached room and enclosure and each scrubber having a clarifier below with attached overflow duct and weir, wherein all said seawater with said 3% salt compound, enters scrubber No 1 and its effluent is pumped to scrubber No 2 and its effluent is pumped to scrubber No 3 But the required 102% of said CO₂ enters scrubber No 1, where about 96% of CO₂ will brake apart about 94% of said 3% salt compounds in said seawater. Only 2% of said 102% CO is emission to the sky. The rest 0.018% of said salt compounds enter scrubber No 2, where 16 CO₂ molecules for each salt compound molecule, are braking apart practically all of them. In scrubber No 3, there are millions of CO₂ molecules for each remnant salt compound molecule to seek and brake them up, leaving said seawater with no objectionable salt.

11. A process according to proceeding claims. characterized in that where it is needed, said seawater can be sterilized by infrared light to kill any organic substance, which can be removed by flocculation in a process tank with a free standing partition where a vertical aerator at the end aerate and flocculate the circulating seawater numerous times before it overflows into a clarifier, where the sludge from flocks and organics settle and is repeatedly returned to process tank before it is wasted, and clear seawater overflows with very low, acceptable BOD.
